(19) United States
(12) Patent Application Publication
(10) Pub. No.: US 2022/0149707 A1
(43) Pub. Date: May 12, 2022

(54) THREE-PHASE ALTERNATING-CURRENT SYNCHRONOUS MOTOR AND ELECTRICAL EQUIPMENT

(71) Applicant: LUTIAN MACHINERY CO., LTD. OF ZHUHAI, Zhuhai (CN)

(72) Inventor: Boqing LI, Zhuhai (CN)

(21) Appl. No.: 17/427,297

(22) PCT Filed: Dec. 30, 2019
(86) PCT No.: PCT/CN2019/129849

§ 371 Date: Jul. 30, 2021

(30) Foreign Application Priority Data
Feb. 1, 2019 (CN) 201910105716.0
Apr. 16, 2019 (CN) 201910301886.6

(51) Int. Cl. H02K 16/02; H02K 7/108; H02K 1/2793

(52) U.S. Cl. CPC H02K 16/02; H02K 1/2793; H02K 7/108

(57) ABSTRACT

Disclosed are a three-phase alternating-current synchronous motor with an improved structure, and electrical equipment. The three-phase alternating-current synchronous motor includes a stator (13) and a rotor, where the rotor includes a driving rotor (14) and a driven rotor (15) that are arranged coaxially, with a rotor shaft (153) being fixed to the driven rotor, and during starting, the driving rotor firstly rotating and then driving the driven rotor to rotate. The electrical equipment includes an industrial fan, an air compressor, an elevator, an aerator and a winch that use a three-phase alternating-current synchronous motor.

### TECHNICAL FIELD

The invention relates to a three-phase alternating-current synchronous motor with an improved structure and electrical equipment driven by the improved motor and, in particular, to a three-phase alternating-current synchronous motor with an improved rotor structure and an electrical equipment including the three-phase alternating-current synchronous motor.

### TECHNICAL BACKGROUND

When the existing three-phase alternating-current synchronous motor is loaded, the three-phase alternating-current synchronous motor cannot be started directly without the controller. One of the functions of the controller is to reduce the frequency of the three-phase alternating-current power to start, and then gradually increase the frequency to 50 Hz or higher, so that the loaded motor can smoothly output power during this process, and will not produce an impact on the power line.

### Technical Problems

The existing three-phase alternating-current synchronous motors all need to be used in conjunction with the controller or use asynchronous starting. However, the controller structure is complicated. The motor adopts asynchronous starting mode. First, the rotor structure is complicated, and second, the motor speed cannot be designed to be low. Both solutions are costly and prone to failure.

### Technical Solutions

After long-term observation and experiments, the inventor of the present invention found that if the starting load is small enough, such as no load, the three-phase alternating-current synchronous motor can be started without a controller. For the three-phase alternating-current synchronous motor, the load does not need to be started immediately. For responsive use occasions, if the controller can be omitted, huge economic benefits will be produced.

The main purpose of the present invention is to provide a three-phase alternating-current synchronous motor that can start smoothly without a controller and has little impact on the power line.

Another object of the present invention is to provide an electrical appliance driven by the above-mentioned three-phase alternating-current synchronous motor.

In order to achieve the above-mentioned main purpose, the three-phase alternating-current synchronous motor provided by the present invention includes a stator and a rotor. The rotor includes a driving rotor and a driven rotor arranged coaxially. The driven rotor is fixed with a rotor shaft. When starting, the driving rotor rotates first. Then drive the driven rotor to rotate.

A further solution is that the driving rotor is coupled with the driven rotor through a clutch and/or a damper.

Since the driving rotor is connected to the driven rotor through a clutch and/or a damper, the driving rotor that is started after power-on rotates relative to the driven rotor, and because the driven rotor is connected to the driven rotor through a clutch and/or damper with a slow loading effect. The driving rotor is connected, and the driven rotor is relatively lagging and slowly driven until it rotates synchronously with the driving rotor. In this process, the load on the rotor shaft is slowly applied after the driving rotor has rotated a certain angle. Therefore, on the one hand, the start-up is realized without the frequency converter, and on the other hand, the impact on the power line is greatly reduced.

A further solution is that the driven rotor contains a structural part of a magnetically permeable material.

Another further solution is that the driving rotor is coupled with the driven rotor through a torque limiter.

Since the driving rotor is connected to the driven rotor through the torque limiter, the driving rotor slips relative to the driven rotor in a short period of time after power-on, and then the driven rotor is relatively slowly driven by the driving rotor through the torque limiter until it is synchronized with the driving rotor In this process, the load on the rotor shaft is slowly applied to the driving rotor after the driving rotor has rotated a certain angle. Therefore, on the one hand, the starting is realized without the controller, and on the other hand The impact on power lines is greatly reduced. The torque limiter of this scheme is also called a torque limiter in the prior art, a safety coupling or a flexible coupling, which has angle compensation performance. When the motor starts, the driving rotor and the driven rotor slip due to overload, and then the connection between the driving rotor and the driven rotor is gradually restored, that is, the lagging connection.

A further solution is that the torque limiter has a three-phase alternating-current synchronous motor that makes the driving rotor slide relative to the driven rotor when the three-phase alternating-current synchronous motor is started, and the driving rotor lags behind to drive the sliding torque of the driven rotor after rotation.

A further solution is that the driven rotor has a driven rotor body fixed relative to the rotor shaft, and the torque limiter includes a friction tong that rotates with the driven rotor body; a ring-shaped brake disc, a part of the brake disc is located in the jaws of the friction tong, The outer circumferential wall of the brake disc is fixed at least in the circumferential direction and the radial direction relative to the inner circumferential wall of the driving rotor.

A further solution is that the friction clamp includes a clamp body, a pair of friction plates forming the jaws and a pressure plate arranged in the clamp body, the pressure plate is fixed on the clamp body by a fastener, and the pressure plate and the friction plate are arranged between an elastic piece that forces the jaws to engage.

Another further solution is that the driven rotor has a first driven rotor body that is fixed relative to the rotor shaft, and a second driven rotor body that is circumferentially fixed relative to the rotor shaft and slides in the axial direction; A driven rotor body and a second driven rotor body are fixed with multiple pieces of passive friction plates, and multiple pieces of driving friction plates are fixed relative to the driving rotor in the circumferential direction, and multiple pieces of passive friction plates and multiple pieces of driving friction plates are alternately stacked in the axial direction And it receives positive pressure for generating friction in the axial direction; the outer peripheral wall of the driving friction plate is fixed at least in the circumferential direction relative to the inner peripheral wall of the driving rotor.

A still further solution is that the torque limiter further includes a first compression spring forcing the second driven rotor body to approach the first driven rotor body in the axial direction; passing through the spring seat hole on the first driven rotor body in the axial direction, A compression screw fastened on the second driven rotor body or through the spring seat hole on the second driven rotor body and fastened on the first driven rotor body; the first compression spring is arranged in the spring seat hole.

A still further solution is that the torsion limiter further includes a second compression spring forcing the second driven rotor body to approach the first driven rotor body in the axial direction; one end of the rotor shaft has a cylindrical cavity, and the axial end surface of the end is arranged There is a pressure regulating screw that penetrates into the cylindrical cavity in the axial direction. The circumferential wall of the cylindrical cavity is provided with a radially penetrating waist round hole. The long axis of the waist round hole is along the axial direction. A pin penetrates the waist round hole and is fastened to it. On the second driven rotor body, the second compression spring is arranged in the cylinder of the rotor shaft and is pressed between the pressure regulating screw and the pin.

Another further solution is that the driving rotor has a driving rotor cavity that seals the driven rotor, the driving rotor cavity contains lubricating oil, and the torque limiter is located in the driving rotor cavity.

A further solution is that one end of the rotor shaft has a cylindrical cavity, the axial end surface of the end is provided with a pressure regulating screw that penetrates the cylindrical cavity in the axial direction, and the circumferential wall of the cylindrical cavity is provided with a radial penetrating Waist round hole, the long axis of the waist round hole is along the axial direction, a pin penetrates the waist round hole and presses against the axial end surface of the second driven rotor body facing away from the first driven rotor body; the cylindrical cavity passes through the waist round hole communicates with the driving rotor cavity.

In order to achieve another objective of the present invention, the electrical equipment provided by the present invention includes a motor, and the motor adopts the three-phase AC synchronous motor in any of the above solutions.

A further solution is that the electrical equipment includes an industrial fan or an air compressor or an aerator or an elevator or a hoist.

### Effectiveness

The present invention adopts the design concept of no-load start and hysteresis loading, and through the improved design of the rotor structure, the three-phase alternating-current synchronous motor can be started by direct power supply without the controller.

### BRIEF DESCRIPTION OF THE DRAWINGS

FIG. 1 is a front view of a first embodiment of a three-phase alternating-current synchronous motor of the present invention;

FIG. 2 is a cross-sectional view of A-A in FIG. 1.

FIG. 3 is an exploded view of the structure of the first embodiment of the three-phase alternating-current synchronous motor of the present invention.

FIG. 4 is a cross-sectional view of the motor housing and stator in the first embodiment of the three-phase alternating-current synchronous motor of the present invention.

FIG. 5 is a structural diagram of the second driven rotor body in the first embodiment of the three-phase alternating-current synchronous motor of the present invention.

FIG. 6 is a B-B cross-sectional view of FIG. 5.

FIG. 7 is a structural diagram of the first driven rotor body in the first embodiment of the three-phase alternating-current synchronous motor of the present invention.

FIG. 8 is a cross-sectional view of C-C of FIG. 7.

FIG. 9 is a perspective view of the rotor shaft in the first embodiment of the three-phase alternating-current synchronous motor of the present invention.

FIG. 10 is a perspective view of the passive friction plate in the first embodiment of the three-phase alternating-current synchronous motor of the present invention.

FIG. 11 is a perspective view of the driving friction plate in the first embodiment of the three-phase alternating-current synchronous motor of the present invention.

FIG. 12 is a cross-sectional structural view of a second embodiment of a three-phase alternating-current synchronous motor of the present invention.

FIG. 13 is a perspective view of the driving rotor and the brake disc in the second embodiment of the three-phase alternating-current synchronous motor of the present invention after being assembled.

FIG. 14 is an exploded view of the structure of the second embodiment of the three-phase alternating-current synchronous motor of the present invention.

FIG. 15 is a front view of the driven rotor body in the second embodiment of the three-phase alternating-current synchronous motor of the present invention.

FIG. 16 is a top view of FIG. 15.

FIG. 17 is a perspective view of the rotor shaft in the second embodiment of the three-phase alternating-current synchronous motor of the present invention.

FIG. 18 is a perspective view of the friction pliers in the second embodiment of the three-phase alternating-current synchronous motor of the present invention omitting the buffer rubber body.

FIG. 19 is a D-D cross-sectional view of FIG. 18.

FIG. 20 is a cross-sectional view taken along the line E-E of FIG. 18.

FIG. 21 is a perspective view of the friction clamp in the second embodiment of the three-phase alternating-current synchronous motor of the present invention with the cushion rubber body omitted from another perspective.

FIG. 22 is a cross-sectional view of the driving rotor, the driven rotor and the friction tongs in the assembled state of the three-phase alternating-current synchronous motor according to the second embodiment of the present invention.

FIG. 23 is a cross-sectional structural view of a third embodiment of a three-phase alternating-current synchronous motor of the present invention.

FIG. 24 is an exploded view of the structure of the third embodiment of the three-phase alternating-current synchronous motor of the present invention.

FIG. 25 is a front view of the lower driving rotor body in the third embodiment of the three-phase alternating-current synchronous motor of the present invention.

FIG. 26 is a perspective view of FIG. 25.

FIG. 27 is a front view of the upper driving rotor body in the third embodiment of the three-phase alternating-current synchronous motor of the present invention.

FIG. 28 is a perspective view of FIG. 27.

FIG. 29 is a front view of the second driven rotor body in the third embodiment of the three-phase alternating-current synchronous motor of the present invention.

FIG. 30 is a perspective view of FIG. 29.

FIG. 31 is a perspective view of the first driven rotor body in the third embodiment of the three-phase alternating-current synchronous motor of the present invention.

FIG. 32 is a structural diagram of the compression spring plate in the third embodiment of the three-phase alternating-current synchronous motor of the present invention.

FIG. 33 is a structural diagram of a passive friction plate in a third embodiment of a three-phase alternating-current synchronous motor of the present invention.

FIG. 34 is a structural diagram of the driving friction plate in the third embodiment of the three-phase alternating-current synchronous motor of the present invention.

FIG. 35 is a perspective view of the rotor shaft in the third embodiment of the three-phase alternating-current synchronous motor of the present invention.

FIG. 36 is an exploded view of the structure of the fourth embodiment of the three-phase alternating-current synchronous motor of the present invention.

FIG. 37 is a cross-sectional view of the fourth embodiment of the three-phase alternating-current synchronous motor of the present invention.

FIG. 38 is a perspective view of the fourth embodiment of the three-phase alternating-current synchronous motor of the present invention with the end cover and a driven rotor half removed.

FIG. 39 is a perspective view of the driving rotor in the fourth embodiment of the three-phase alternating-current synchronous motor of the present invention.

FIG. 40 is a front view of the driving rotor in the fourth embodiment of the three-phase alternating-current synchronous motor of the present invention.

FIG. 41 is a cross-sectional view of F-F in FIG. 40.

FIG. 42 is a perspective view of the driven rotor in the fourth embodiment of the three-phase alternating-current synchronous motor of the present invention.

FIG. 43 is a front view of the driven rotor in the fourth embodiment of the three-phase alternating-current synchronous motor of the present invention.

FIG. 44 is a cross-sectional view of the driven rotor passing through the axis in the fourth embodiment of the three-phase alternating-current synchronous motor of the present invention.

FIG. 45 is a perspective view of the same perspective after removing a driven rotor half in FIG. 42.

FIG. 46 is a front view of FIG. 45 from a direction perpendicular to the axis.

FIG. 47 is a plan view of FIG. 45 along the axial direction.

FIG. 48 is a G-G cross-sectional view of FIG. 47, which is rotated 90 degrees clockwise.

### EMBODIMENTS OF THE INVENTION

The various embodiments of the present invention will be further described below in conjunction with various embodiments and the accompanying drawings.

The First Embodiment of Three-Phase Alternating-Current Synchronous Motor

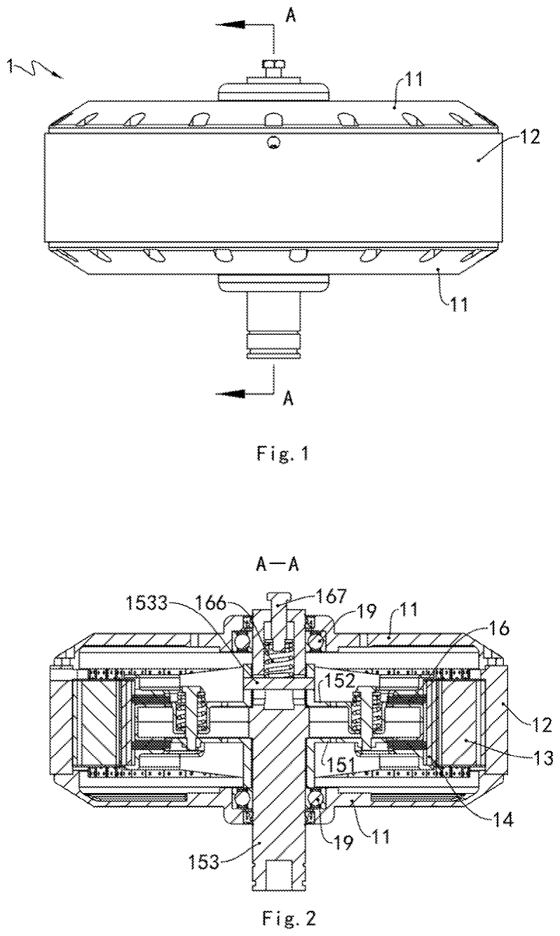

Referring to FIG. 1, the three-phase alternating-current synchronous motor 1 of the present invention has a housing 12 and a cover 11 fastened to it by fasteners. It is a 40-pole three-phase alternating-current synchronous motor. Those skilled in the art can understand that for a three-phase alternating-current synchronous motor with a 16-level magnetic pole or an even number-increasing magnetic pole on this basis, the three-phase alternating-current synchronous motor can be directly used according to the present invention without a frequency converter. Start, and the more the number of poles, the lower the speed of the three-phase alternating-current synchronous motor, and the better it is to start.

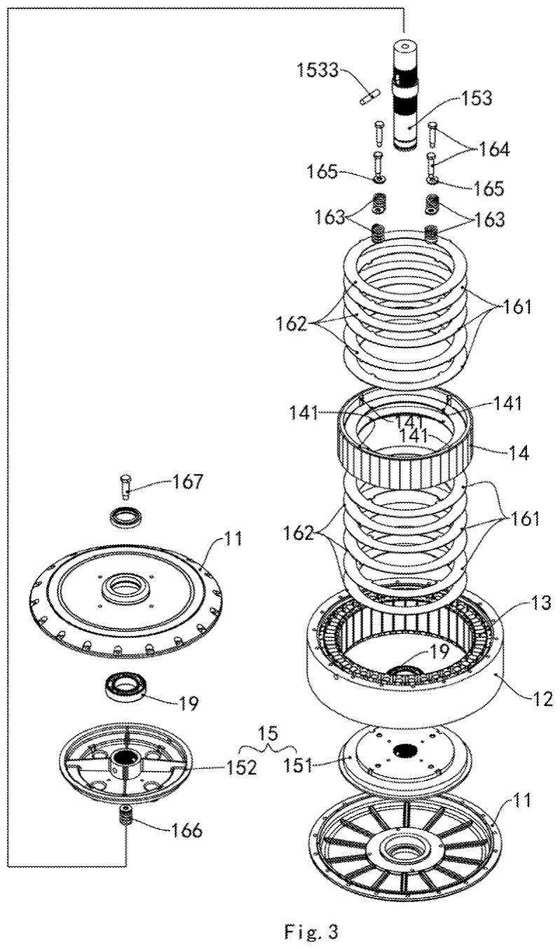

Referring to FIG. 2, the stator 13 is fixedly installed in the housing 12, the rotor shaft 153 is supported by a pair of bearings 19 respectively installed on the two covers 11, and the driven rotor 15 (see FIG. 3) is supported by the first driven rotor body 151 and the second driven rotor body 152, where the first driven rotor body 151 is fixed on the rotor shaft 153, and the shaft hole of the second driven rotor body 152 is connected with the rotor shaft through a feather key, and then is in the circumferential direction relative to the rotor shaft 153. The fixed axis is slidable. The driving rotor 14 and the driven rotor 15 are coaxially arranged. Four tooth grooves 141 extending in the axial direction are provided on the inner peripheral wall. The driving rotor 14 is restricted by the eaves of the driven rotor 15 in the radial and axial directions. The driving rotor 14 and the passive shaft 15 are connected by a torque limiter 16.

Referring to FIG. 3, the torque limiter 16 of this example includes multiple passive friction plates 161, multiple driving friction plates 162, four first compression springs 163, four compression screws 164, four washers 165, one second compression spring 166 and a pressure regulating screw 167 are constituted. A sealing ring is provided between the shaft hole of the cover 11 and the rotor shaft 153.

With reference to FIGS. 2 and 3, the multiple passive friction plates 161 and the multiple driving friction plates 162 are alternately stacked in the axial direction, and both are annular plates. The compression screw 164 covered with the washer 165 and the first compression spring 163 passes through the spring seat hole on the second driven rotor body 152 and is tightly fixed in the screw hole of the first driven rotor body 151, so that the first compression spring 163 is fixed. In the spring seat, the restoring force of the first compression spring 163 forces the second driven rotor body 152 to approach the first driven rotor body 151 in the axial direction, thereby causing the interleaved driving friction plates 162 and the passive friction plates 161 to be axially affected. The upward pressure is a positive pressure that generates friction when the driving friction plate 162 has a tendency to rotate around the axis relative to the passive friction plate 161. By tightening or loosening the compression screw 164, the magnitude of the positive pressure can be adjusted, that is, the sliding torque of the torque limiter can be adjusted, so that the torque limiter 16 can satisfy the requirements of the driving rotor immediately when the motor starts. It rotates and slides relative to the driven rotor, and the hysteresis drives the driven rotor to gradually rotate synchronously. The second compression spring 166 is placed in the rotor shaft 153, one end is pressed against the pin 1533, and the other end is low pressure at the lower end of the pressure regulating screw 167, which can fine-tune the sliding torque. The specific structure and fine-tuning method will be described in detail later.

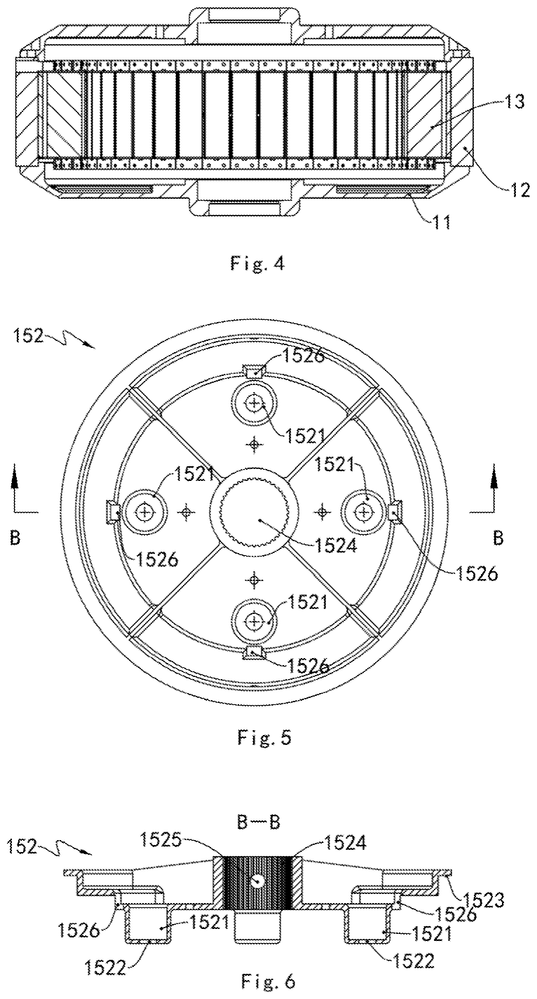

Referring to FIG. 4, the stator 13 is fixed in the cover 11 and the housing 12, and its structure can be implemented according to the prior art.

Referring to FIGS. 5 and 6, the second driven rotor body 152 is provided with four spring seats 1521, an annular upper eave 1523, a shaft hole 1524, a pin hole 1525, and four axially extending tooth grooves 1526. The bottom of the spring seat 1521 is provided with a spring seat hole 1522 for the compression screw 164 to pass through. The shaft hole 1524 is matched with the rotor shaft 153 through a sliding key, and the pin hole 1525 is used to fix the pin 1533.

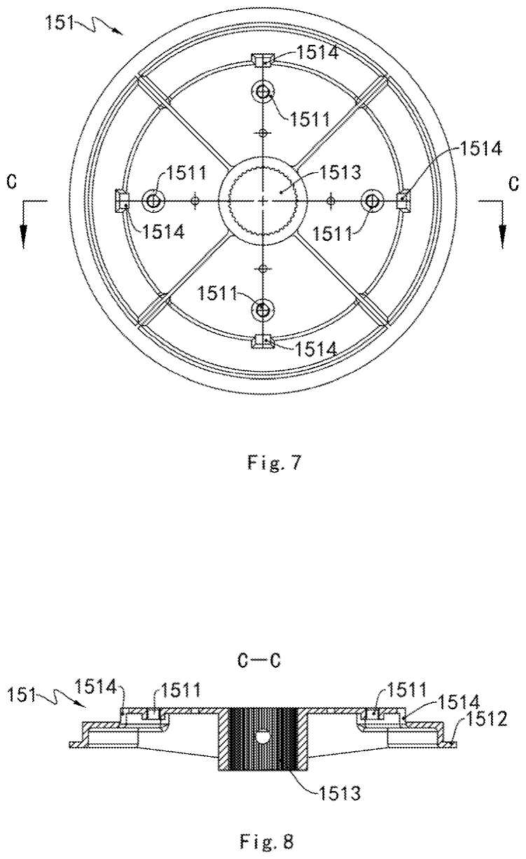

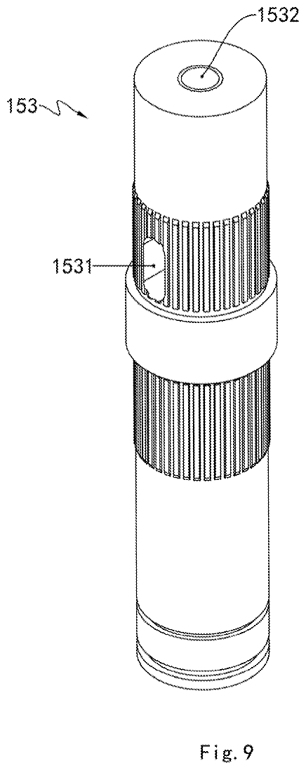

Referring to FIGS. 7 and 8, the first driven rotor body 151 is provided with four screw holes 1511, a ring-shaped lower eave 1512, a shaft hole 1513, and four axially extending tooth grooves 1514. The compression screw 164 is screwed into the screw hole 1511, and the eaves for constraining the driving rotor 14 in the radial and axial directions are composed of an upper eaves 1523 and a lower eaves 1512, so that the driving rotor 14 can be opposed to the driven rotor 15 rotate and slide coaxially.

Obviously, the spring seat 1521 can be arranged on the first driven rotor body 151, and the screw hole 1511 is arranged on the second driven rotor body 152, and the compression screw 164 is installed in the axial direction reverse as described above, and the same can be implemented. And to achieve the design purpose of the present invention.

Referring to FIG. 9, the upper end of the rotor shaft 153 is provided with a cylindrical cavity, and the end surface of the end is provided with a screw hole 1532 for the pressure regulating screw 167 to be screwed in. The circumferential wall of the cylindrical cavity is provided with a radially penetrating waist circle. The hole 1531 and the pin 1533 pass through the waist round hole 1531 and can move in the axial direction. When the pressure regulating screw 167 is tightened or loosened, the restoring force of the second compression spring 166 in the cylindrical cavity changes to make the second the driven rotor body 152 moves relative to the rotor shaft 153 in the axial direction to achieve fine adjustment of the sliding torque.

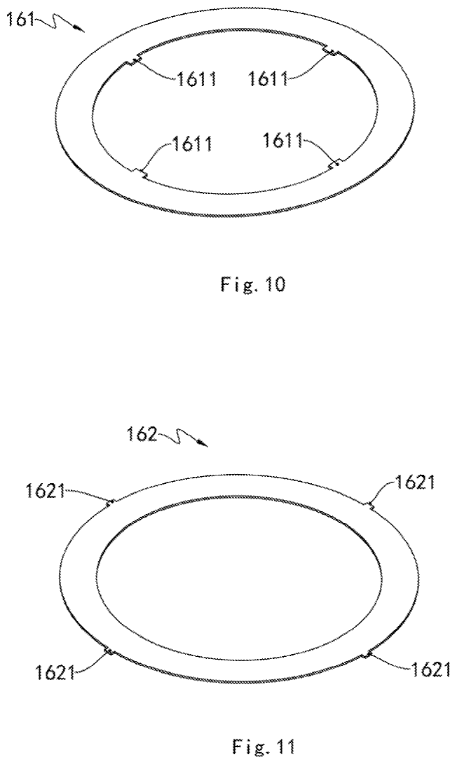

Referring to FIG. 10, there are four teeth 1611 extending radially inward on the inner peripheral wall of the passive friction plate 161. The teeth 1621 cooperate with the tooth groove 1526 or the tooth groove 1514 to realize the passive friction plate 161 relative to the second driven rotor. The body 152 or the first driven rotor body 151 is relatively fixed in the circumferential direction.

Referring to FIG. 11, there are four radially outwardly extending teeth 1621 on the outer peripheral wall of the driving friction plate 162. The teeth 1621 cooperate with the tooth grooves 141 to realize the circumferential fixation of the driving friction plate 162 relative to the driving rotor 14.

In the case of omitting the controller, in order to use three-phase AC mains to directly start the three-phase AC synchronous motor, the main inventive concept of the present invention is to reduce the weight of the rotor as much as possible. The technical solution provided by the present invention is to design the rotor. The driving rotor and the driven rotor are formed, and the driven rotor outputs power, and the driven rotor is driven by the driving rotor lagging, that is, the driven rotor is driven to rotate after the driving rotor is started under light load conditions.

The Second Embodiment of Three-Phase Alternating-Current Synchronous Motor

In the following, only the differences in the structure and connection relationship between this example and the first embodiment of the three-phase AC synchronous motor will be described in detail, and the similarities will not be repeated.

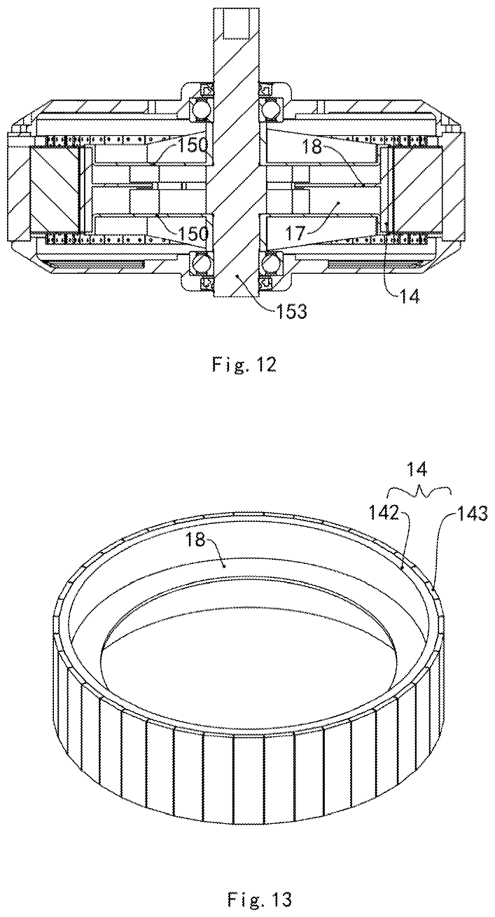

Referring to FIG. 12, the driving rotor 14 of this example has a simpler structure, with only a rotor barrel and a magnetic steel sheet fixed on its outer peripheral wall, while the driven rotor includes a pair of driven rotor bodies 150 fixed to the rotor shaft 153 The torque limiter includes a pair of friction calipers 17 and a brake disc 18 that are fixedly arranged relative to the driven rotor body 150 and rotate with the driven rotor body 150.

Referring to FIG. 13, the driving rotor 4 includes a rotor barrel 142 and a plurality of magnetic steel sheets 143 fixed on the outer peripheral wall thereof. The brake disc 18 is an annular piece, the outer peripheral wall of which is fixedly connected to the inner peripheral wall of the rotor barrel 142, so as to be fixedly connected to the driving rotor. Obviously, if the brake disk 18 is designed in the shape of the driving friction plate 162 with teeth in the above example, and the inner peripheral wall of the rotor barrel 142 is correspondingly provided with strip-shaped grooves, the brake disk 18 is relative to the driving rotor 14 in the circumferential and radial directions. Fixing can also achieve the purpose of the present invention.

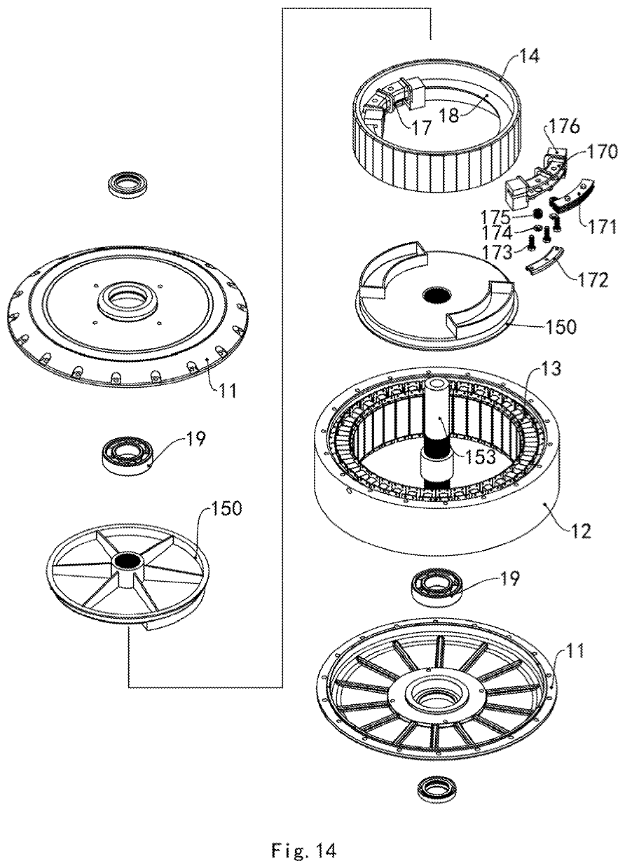

Referring to FIG. 14, the same reference numerals as the above example in the figure refer to the same parts or structures as the above example, a pair of driven rotor bodies 150 are basically symmetrical in structure, and a pair of friction tongs 17 are clamped symmetrically about the axis. Inside the brake disc 150. Each friction pliers 17 includes a pliers body 170, a pair of friction plates 171 that form the jaws, a pressure plate 172, three screws 173, two washers 174, two compression springs 175 and a pair of fixed on the pliers body 170. The buffer rubber body 176 at the circumferential end is constituted.

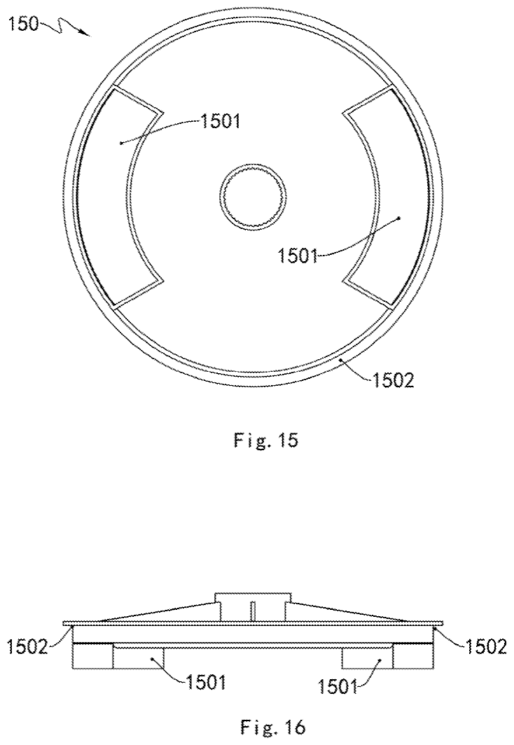

Referring to FIGS. 15 and 16, each driven rotor body 150 is provided with a pair of pliers seats 1501 with axial openings, so as to constrain the friction tongs 17 in the pliers seats 1501 when the driven rotor 15 is assembled. An eave 1502 is also provided on the periphery to limit the driving rotor 14 in the axial and radial directions, so that the driving rotor 14 can only rotate in the circumferential direction relative to the driven rotor. The friction pliers 17 installed in the pliers seat in a resting manner will impact the pliers seat 1501 in the circumferential direction when the driving rotor 14 is slipping relative to the driven rotor. After the buffer rubber body 176 is set, it can effectively buffer and reduce the start. noise. Since the friction pliers 17 is not symmetrical in the axial direction with respect to the jaws, the size of the pliers seat 1501 facing the pressure plate 172 in the axial direction is slightly larger than that of the pliers seat 1501 facing away from it.

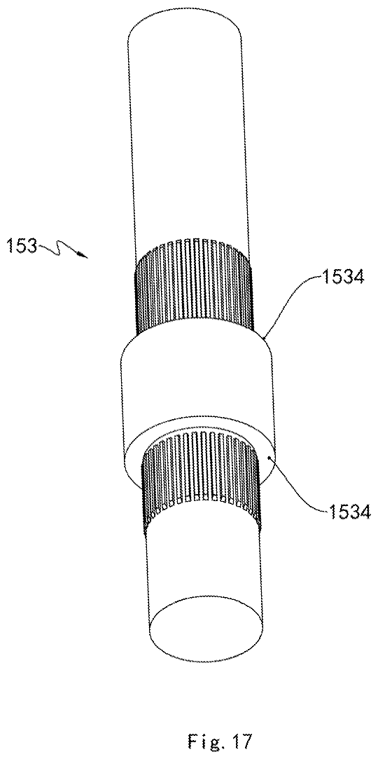

Referring to FIG. 17, the axial distance between the two shoulders 1534 of the rotor shaft 153 for axially limiting the driven rotor body 150 should meet the following conditions, that is, the driven rotor body 150 is installed in position relative to the rotor shaft 153. After that, the driving rotor 14 is in a clearance fit with the driven rotor 15 in the axial direction.

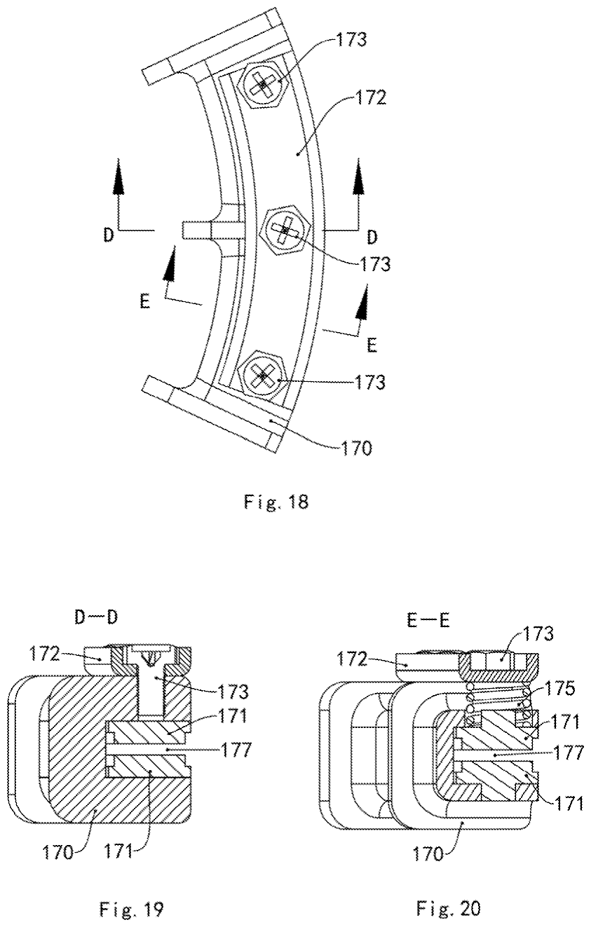

Referring to FIGS. 18 to 20, the pressure plate 172 is fixed on the clamp body 170 by three screws 173, and the pressure plate presses two pressure springs 175 between the friction plate 171 and the washer 174 (not visible in the figure), so that the jaw 177 formed to between the two friction plates 171 engages the part of the brake disc 18 extending into the jaw 177.

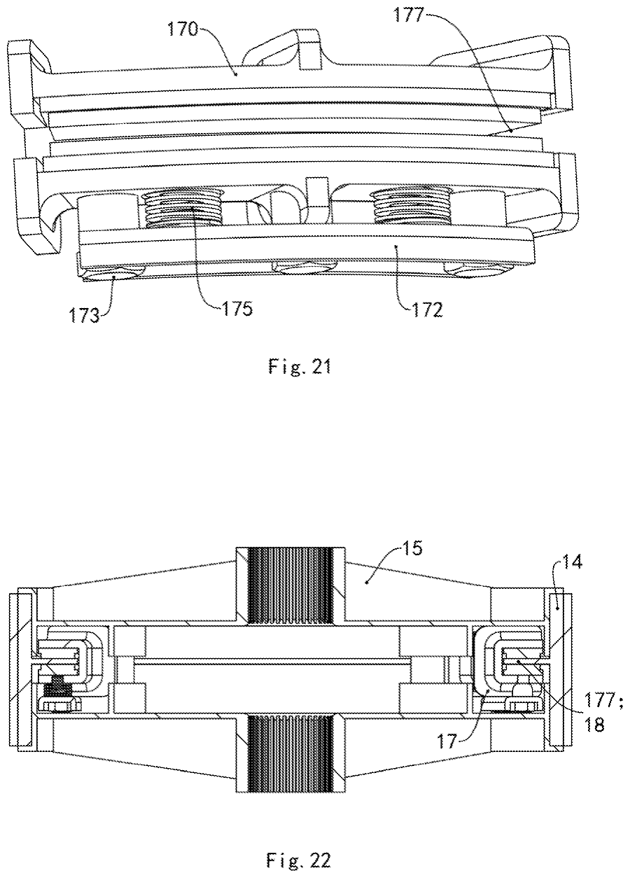

Referring to FIG. 21, by tightening the screw 173, the bite force of the jaw 177, that is, the sliding torque of the torque limiter, can be adjusted.

Referring to FIG. 22, this figure shows the relative positional relationship between the driving rotor 14 and the driven rotor 15, the relative positional relationship between the friction tongs 17 and the driven rotor 15, and the positional relationship between the jaw 177 and the brake disc 18.

Obviously, the driven rotor 15 does not have to be designed with two driven rotor bodies 150. A person skilled in the art can completely design a driven rotor body, with eaves for restricting the driving rotor 14 and fixed friction tongs. The fixed part can also achieve the purpose of the present invention.

The Third Embodiment of Three-Phase Alternating-Current Synchronous Motor

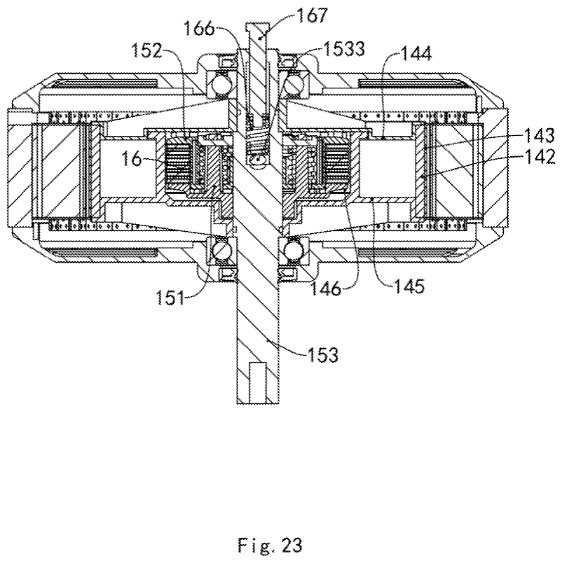

Referring to FIG. 23, the main difference between this example and the previous two examples is that the specific structure and shape of the driving rotor 14, the driven rotor 15 and the torque limiter 16 are different. The driving rotor 14 is made up of a rotor barrel 142, an upper rotor body 144 and a lower rotor 145 body fixedly connected, and a magnetic steel sheet 143 is fixed outside the rotor barrel 142. The characteristic is that a rotor is formed between the upper rotor body 144 and the lower rotor body 145. The driving rotor cavity 146 of the driven rotor 15 is sealed and accommodated, and the driving rotor cavity 146 contains lubricating oil. The driven rotor 15 includes a first driven rotor body 151 fixedly connected to the rotor shaft 153 and a second driven rotor body 152 which is fixed and axially sliding relative to the rotor shaft 153 in the circumferential direction. The functions of a pressure regulating screw 167, a second compression spring 166 and a pin 1533 are the same as those of the first example. In addition, they also have the function of injecting and replenishing lubricating oil into the driving rotor cavity 146.

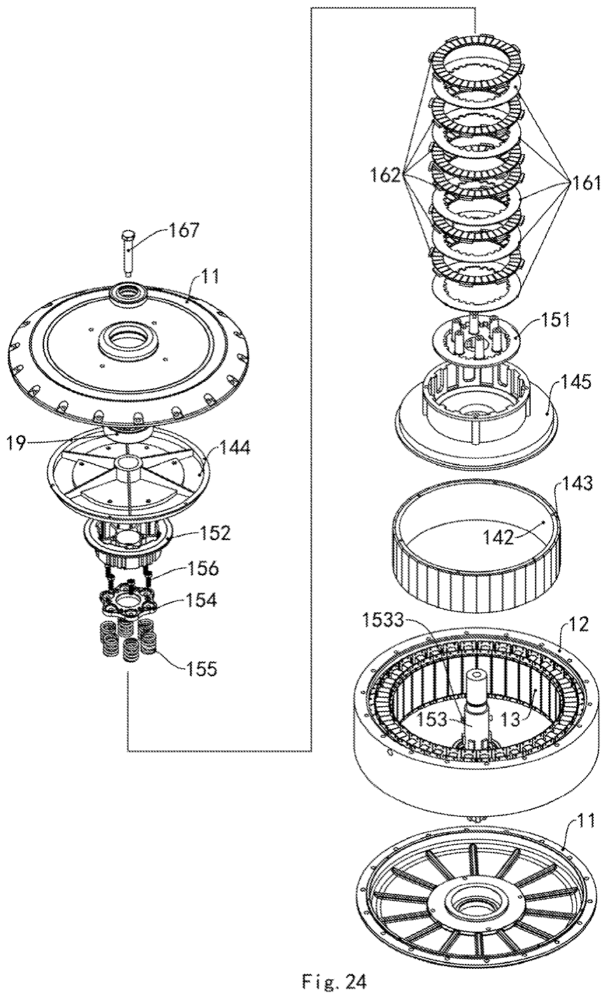

Referring to FIG. 24, the structure of the cover 11, the housing 12, and the stator 13 in this example are exactly the same as those of the previous two examples. The lower rotor body 145 has a driving rotor cavity with an opening facing upward, and the opening is covered by the upper rotor body. 144 seals and covers the driving rotor cavity 146 to form a seal. A set of driving friction plates 161 and a set of passive friction plates 162 are alternately stacked in the axial direction, and are axially squeezed between the first driven rotor 151 and the second driven rotor 152, and are passed through by six compression screws 156 The pressure plate 154 and the spring seat holes on the six first compression springs 155 and the second driven rotor body 152 are tightly fixed on the first driven rotor body 151 to form the main structure of the torque limiter 16 of this example. Considering the factors of cost saving and assembly process, a commercially available CG125 clutch drum assembly for motorcycles is used in this example, so the specific structure will not be described in detail.

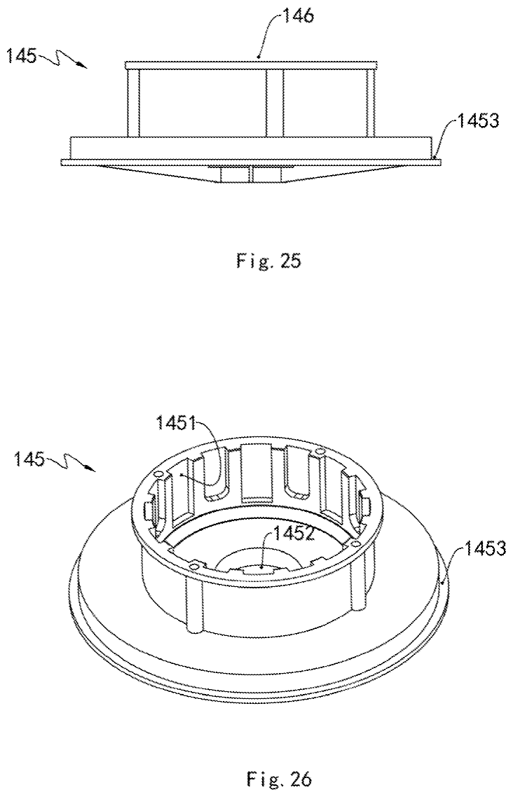

Referring to FIGS. 25 and 26, the lower rotor body 145 has a driving rotor cavity 146 with an open upper end, the eaves 1453 is fixedly connected to the rotor barrel 142, and the inner surface of the peripheral wall forming the driving rotor cavity 146 is provided with an axial. The tooth groove 1451 is matched with the driving friction plate 161, that is, the outer teeth of the friction plate of the clutch and snare drum assembly. The shaft hole 1452 is in clearance fit with the rotor shaft 153, and an oil seal necessary to form the driving rotor cavity 146 is provided between the shaft hole 1452 and the rotor shaft 153.

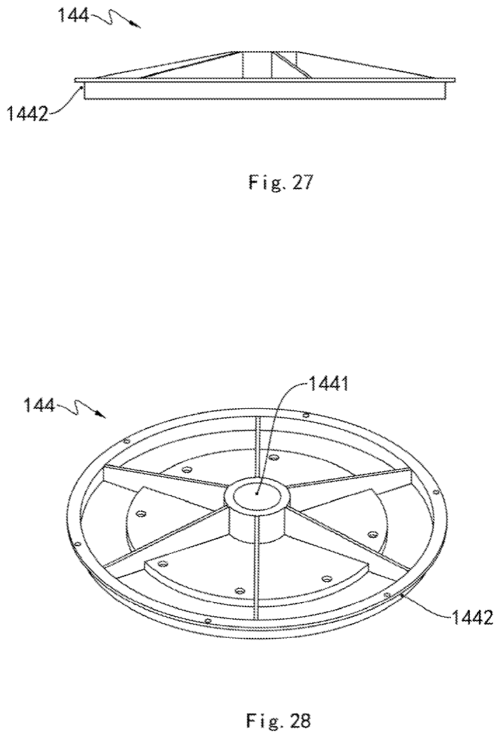

Referring to FIGS. 27 and 28, the upper rotor body 144 has an eaves 1442 and a shaft hole 1441 that cooperates with the rotor shaft 153 through an oil seal. When the clutch snare drum assembly is installed in the driving rotor cavity 146, the fasteners and after the sealing ring is assembled to form the sealed driving rotor cavity 146, the eaves 1442 and the rotor barrel 142 are fixedly connected.

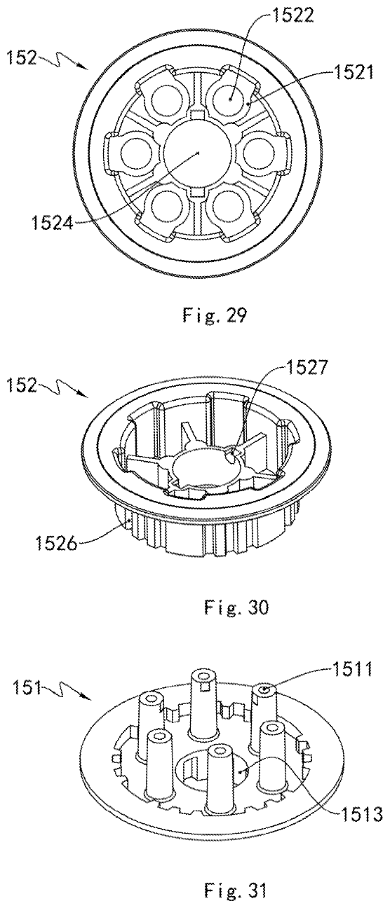

Referring to FIGS. 29 and 30, the second driven rotor 152 has six compression spring seats 1521, a spring seat hole 1522, a shaft hole 1524 that is clearance fit with the rotor shaft 153, and a plurality of axially extending tooth grooves 1526, The pin groove 1527 on the axial end surface is used to constrain the pin 1533.

Referring to FIG. 31, the first driven rotor 151 is provided with six screw holes 1511 for screwing in the compression screws 156, and the shaft hole 1513 is fixedly connected with the rotor shaft 153.

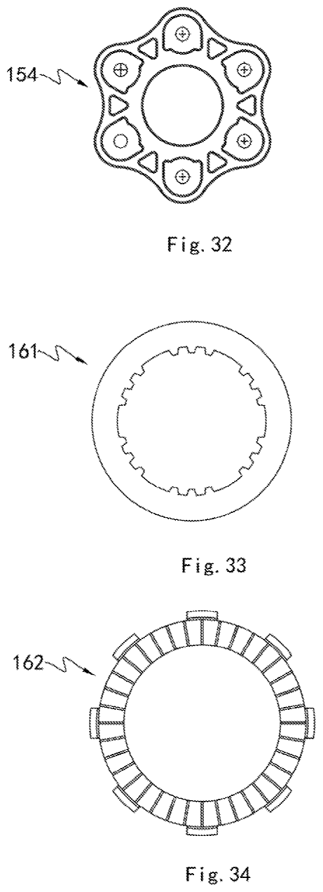

Referring to FIG. 32, the pressing plate 154 in this example has the same function as the pressing plate 172 in the second example.

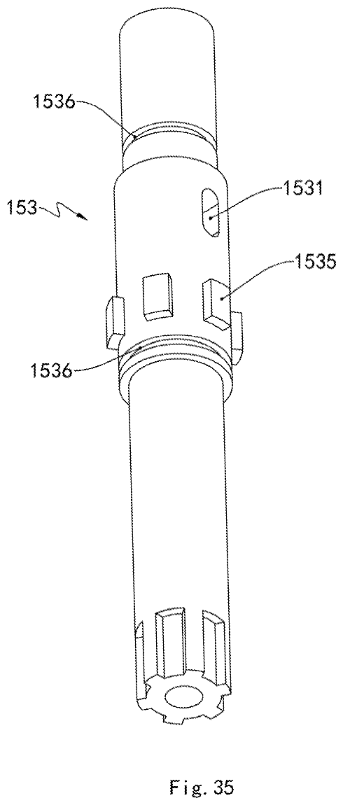

Referring to FIGS. 33 and 34, the driving friction plate 162 and the passive friction plate 161 in this example have exactly the same functions as the corresponding friction plates in the first example, and the structure is only slightly different in the arrangement of the teeth.

Referring to FIG. 35, the rotor shaft 153 is provided with a spline 1535 for assembling the clutch snare drum assembly, a waist round hole 1531 through which the pin 1533 passes and slides relatively, and the waist round hole 1531 communicates with the sealed driving rotor cavity 146. In addition, the rotor shaft 153 is also provided with an annular groove 1536 for fixing the oil seal.

Fourth Embodiment of Three-Phase Alternating-Current Synchronous Motor

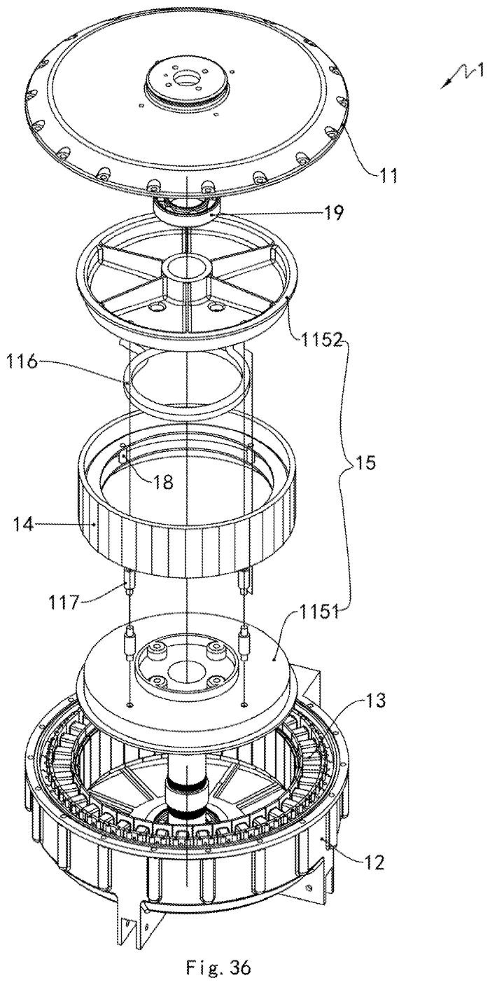

Referring to FIG. 36, the three-phase alternating-current synchronous motor 1 of the present invention has a housing 12 and a cover 11 fastened to it by fasteners, and is a 40-pole three-phase alternating-current synchronous motor.

The stator 13 is fixedly installed in the housing 12. The rotor shaft is supported by a pair of bearings 19 respectively fixed on the housing 12 and the cover 11. The driven rotor 15 includes a driven rotor half body 1151 and a driven rotor half body 1152, And fixed on the rotor shaft, in the axial direction, the driving shaft 14 is located between the driven rotor half 1151 and the driven rotor half 1152. The four driven rotor pins 117 are evenly arranged on the driven rotor 15 in the circumferential direction, and the four driving rotor pins 118 are evenly arranged on the driving rotor 14 in the circumferential direction. A torsion spring 116 serving as a damper is arranged between the driven rotor half 1151 and the driven rotor half 1152 viewed from the axial direction, and between the rotor shaft and the driving rotor 14 viewed from the radial direction.

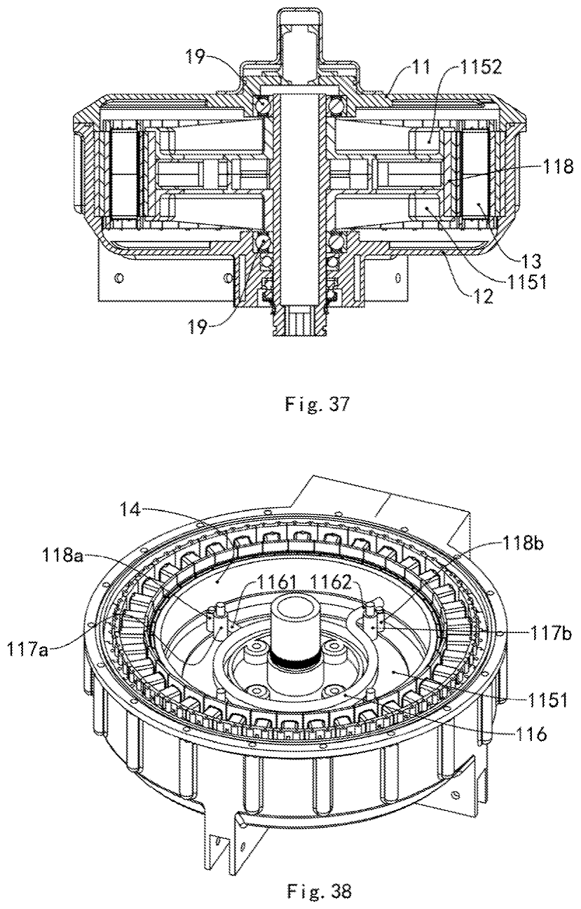

Referring to FIGS. 37 and 38, FIG. 36 disassembles the main components of the fourth embodiment of the three-phase AC synchronous motor of the present invention in the axial direction. In FIG. 37, the torsion spring in FIG. 36 is omitted. In addition to 116, the connection position relationship of the main components in the axial direction is more clearly shown, and FIG. 38 is used to describe in detail the connection relationship between the driving rotor 14 and the driven rotor 15 and the working principle. The driving rotor pins 118 (118a, 118b) and the driven rotor pins 117 (117a, 117b) are both provided with four positions, which are used to buffer the connection between the driving rotor 14 and the driven rotor 15 for the purpose of rotor dynamic balance. Only two of them are required. The coil of the torsion spring 116 is sleeved on the axial inner boss of the driven rotor 15. In the static state, as shown in FIG. 38, the torsion arm 1161 and the torsion arm 1162 are in relative positions to the pins. When the driving rotor 14 starts clockwise, the torsion arm 1161 abuts the driving rotor 14 through the driving rotor pin 118a, and the torsion arm 1162 abuts against the driven rotor 15 through the driven rotor pin 117b. At this time, the restoring force of the torsion spring 116 is the smallest. For example, it is approximately zero, so the driven rotor 15 does not rotate with the driving rotor 14. As the rotation angle of the driving rotor increases, the restoring force of the torsion spring 116 gradually increases, so that the driven rotor 15 lags behind the driving rotor 14 to rotate clockwise. In the above process, the driving rotor 14 is started without the participation of the frequency converter due to its small mass, and has minimal impact on the power line. When the driven rotor 15 rotates relatively slowly, it is equivalent to the start of the entire rotor. After completion, the impact on the power line is relatively gentle. As the restoring force of the torsion spring 116 continues to increase, even when the torsion arm 1162 abuts against the driving rotor pin 118a, the driven rotor 15 and the driving rotor 14 will rotate at the same angular velocity. When the motor needs to rotate in the reverse direction, that is, when it starts counterclockwise in the state in FIG. 38, the torsion arm 1162 abuts against the driving rotor 14 through the driving rotor pin 118b, and the torsion arm 1161 abuts against the driven rotor 15 through the driven rotor pin 117a. Furthermore, the driven rotor 15 is driven slowly.

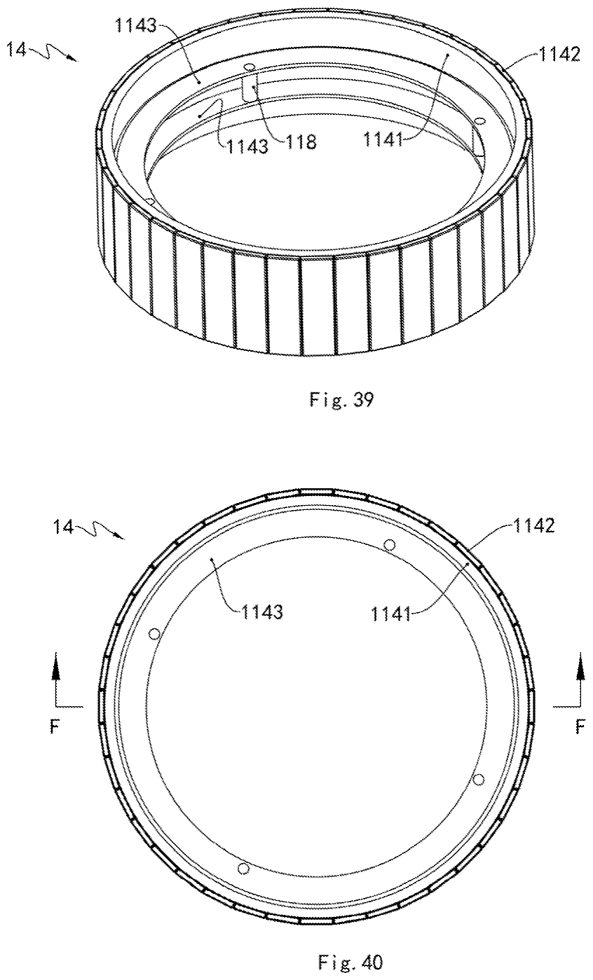

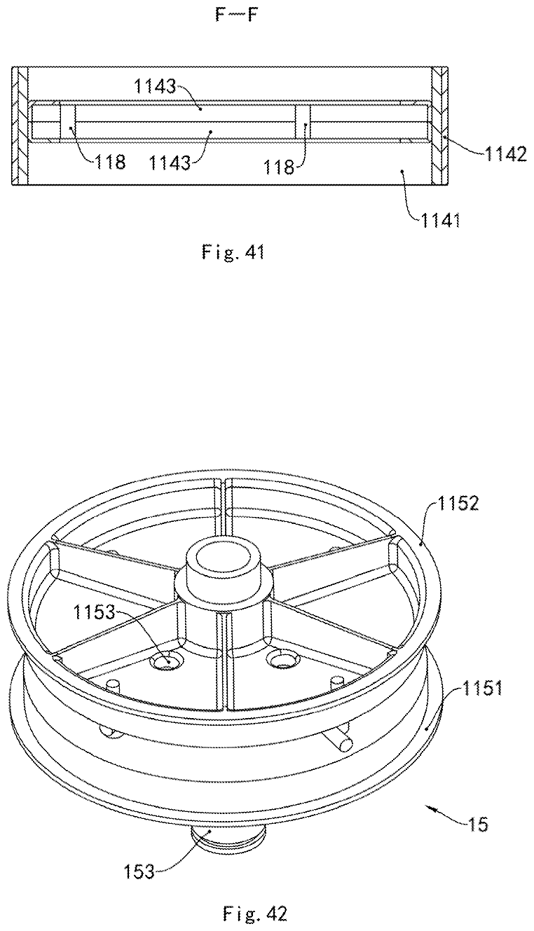

Referring to FIG. 39, FIG. 40 and FIG. 41, from a technological point of view, the driving rotor 14 of this example includes a driving rotor body 1141, 40 pole pieces 1142 fixed on the outer wall of the driving rotor body 1141, and fixed on the driving rotor body. Two positioning rings 1143 on the inner wall of 1141 and four driving rotor pins 118 are formed.

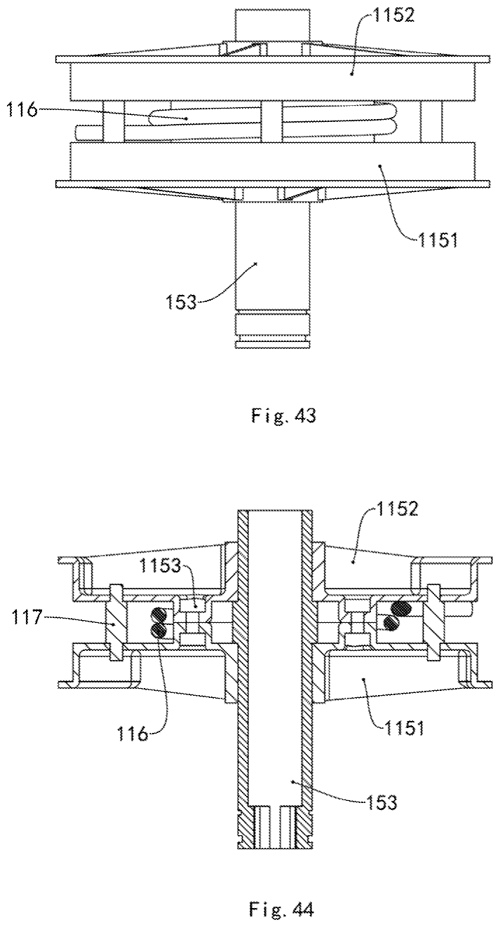

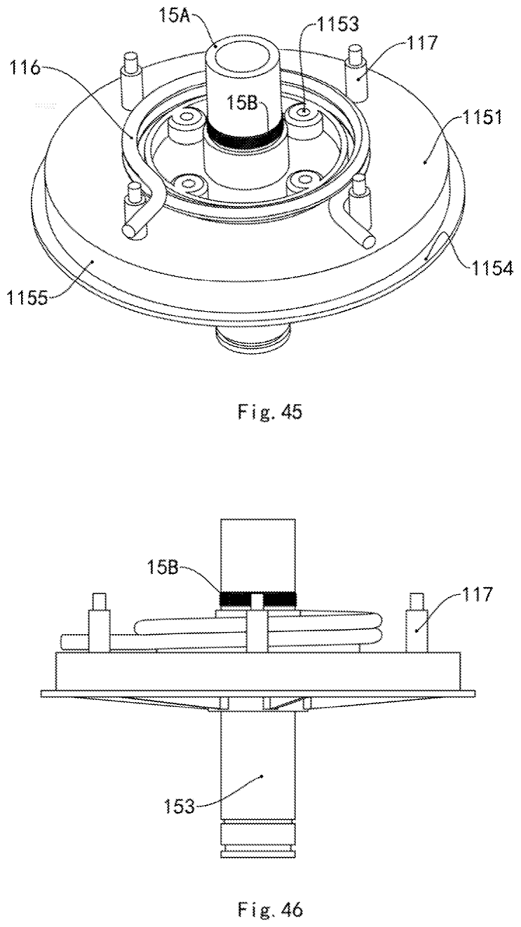

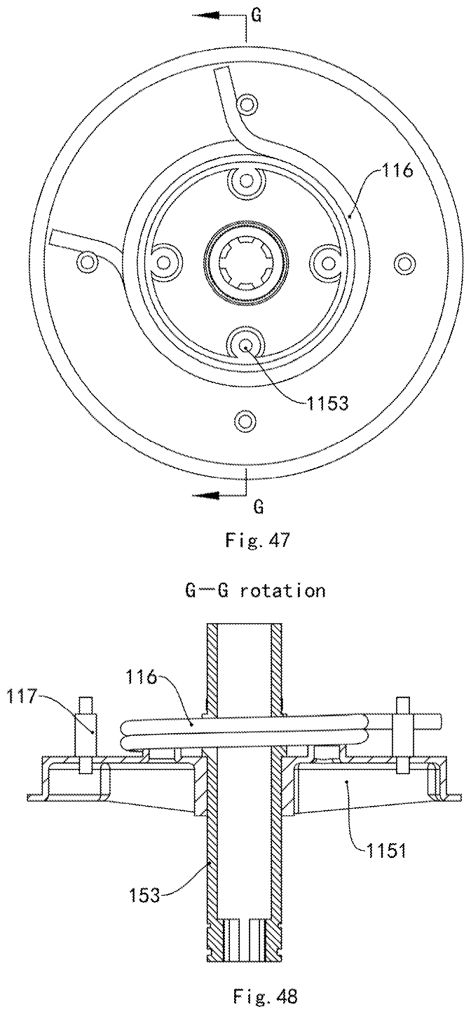

Referring to FIGS. 42 to 48, the driven rotor 15 includes a driven rotor half 1151 and a driven rotor half 1152, and is fixed on the rotor shaft 153. The fixing method is that the rotor shaft 153 is provided with a spline in the axial fixed section Tooth 15B, the inner wall of the hole on the driven rotor half is correspondingly provided with spline grooves, and the two are tightly fitted to achieve an interference fit between the axial directions. There are four fasteners passing through the hole 1153 to connect the two driven rotor halves. The body is relatively reinforced and connected. Since the driving rotor 14 is very light and thin in the radial direction, in order to better improve the magnetic permeability of the rotor, the driven rotor 15 can be made of all magnetic materials, or the area close to the driving rotor can be made of magnetic materials. The part close to the rotor shaft is made of non-magnetic material.

The driving rotor 14 is axially limited by a pair of axial end surfaces 1154 of the driven rotor 15, and radially limited by the circumferential surface 1155 of the driven rotor 15, to achieve relative rotation of the driven rotor 15, that is, axial The end surface 1154 and the circumferential surface 1155 are in a sliding fit relationship between the opposite surfaces of the driving rotor 14 respectively. Viscous grease or damping oil is added between the gaps to make the entire rotation process of the rotor play an additional role of damping and prevent rapid Rebound, so as to eliminate the impact caused by the inertia of the driving rotor 14 and the rebound of the driven rotor 15.

The prototype made according to the fourth embodiment of the present invention has a rated operating current of 2.5 amperes. After many experiments, the startup can be successfully completed. The current peak value at startup is 1.5 amperes to 2.0 amperes. Hundreds of repeated starts, and after several 200 hours of load-increasing operation, there was no large current that impacted the power line.

Fifth Embodiment of Three-Phase Alternating-Current Synchronous Motor

The main difference between this example and the fourth embodiment of the three-phase alternating-current synchronous motor is that the damper adopts a disc-shaped two-way damper or disc-shaped rotary damper instead of torsion springs, and the body of the disc-shaped two-way damper or disc-shaped rotary damper is fixed on the driving on the rotor, the shaft hole on the moving core is fixedly connected with the rotor shaft of the present invention, so that the driven rotor is driven by the driving shaft lagging behind. Since the disc-type bidirectional damper or disc-type rotary damper is a relatively mature technology and can be customized and purchased, the advantage of this example is that the rotor structure is relatively simple and quick to assemble, and the failure rate of the damper is low.

Sixth Embodiment of Three-Phase Alternating-Current Synchronous Motor

The difference between this example and the fourth and fifth examples is that the driving rotor 15A has its own independent driving rotor shaft, and the driven rotor has its own driven rotor shaft. The two shafts are connected to the sleeve through a bearing or shaft. Therefore, they can be synchronized in a coaxial manner. Rotation can also be coaxially relatively rotated, and a friction clutch or a hydraulic clutch is arranged in the space enclosed by the driving rotor and the driven rotor, or a damper can be arranged in the space.

The First Embodiment of Electrical Equipment

The first embodiment of the electrical equipment of the present invention is an industrial electric fan. The industrial electric fan is widely used for ventilation or cooling in workshops and workshops. It includes a bracket, a motor, a fan blade and a shield. The motor adopts the three-phase alternating-current synchronous motor of the present invention. Any one of the above embodiments.

Second Embodiment of Electrical Equipment

As the second embodiment of the electrical equipment of the present invention, an air compressor is used. The air compressor is widely used in production activities that use the compressor as a power source. The compressor in this example is driven by a motor, and the motor adopts the present invention. Any one of the above-mentioned embodiments of the three-phase alternating-current synchronous motor.

The Third Embodiment of Electrical Equipment

As the third embodiment of the electrical equipment of the present invention is an aerator. The aerator is widely used in fishery production. For example, aerators are equipped in fish farms or shrimp farms. The machine is driven by a motor, and the motor adopts the third embodiment of the three-phase alternating-current synchronous motor of the present invention. Utilize the floating body, frame and impeller of the existing aerator, that is, remove the asynchronous motor of an existing aerator, and install a motor of the third embodiment of the three-phase alternating-current synchronous motor of the present invention. The actual detection of the rotation speed of the rotor shaft of the machine, the rotation speed of the rotor with a design rotation speed of 150 rpm is about 110 rpm to 120 rpm when it is started, and the design rotation speed is reached after about 10 seconds. Through the observation of the starting current by the ammeter, the starting current is much smaller than the starting current of the asynchronous motor, that is, under the premise that the synchronous motor has a high power factor, it also has the advantage of greatly reducing the impact on the power line.

The Fourth Embodiment of Electrical Equipment

The fourth embodiment of the electrical equipment of the present invention is an elevator. The elevator is widely used in high-rise buildings, mainly including a car cage, a pulley block, and a motor that uses any one of the above-mentioned three-phase alternating-current synchronous motor embodiments as a driving force.

Fifth Embodiment of Electrical Equipment

The fifth embodiment of the electrical equipment of the present invention is a hoist. The hoist is widely used in the field of engineering construction. It includes a frame, a reel and a motor. The motor adopts any one of the three-phase AC synchronous motor of the present invention in the above-mentioned embodiments.

Those skilled in the art can fully implement the equipment parts other than the motor in the above electrical equipment embodiments according to the existing technology, such as the brackets, fan blades and their shields of industrial electric fans; the floating bodies and racks of aerators wait.

### INDUSTRY APPLICABILITY

In the present invention, the rotor is designed as a driving rotor and a driven rotor. The rotor shaft is arranged on the driven rotor. Since the driving rotor has relatively light weight, the driving rotor can immediately rotate due to its light weight at the moment of power-on, and then drive the driven rotor to rotate.

1. Three-phase alternating-current synchronous motor, comprising a stator and a rotor; wherein:
the rotor includes a driving rotor and a driven rotor arranged coaxially;
the driven rotor is fixed with a rotor shaft; and
when starting, the driving rotor rotates first, and then drives the driven rotor to rotate.

2. The three-phase alternating-current synchronous motor according to claim 1, wherein:
the driving rotor is coupled with the driven rotor through a clutch and/or a damper.

3. The three-phase alternating-current synchronous motor according to claim 1, wherein:
the driven rotor contains structural parts made of magnetically conductive materials.

4. The three-phase alternating-current synchronous motor according to claim 1, wherein:
the driving rotor is connected with the driven rotor through a torque limiter.

5. The three-phase alternating-current synchronous motor according to claim 4, wherein:
the torque limiter has a sliding torque that causes the driving rotor to slide relative to the driven rotor when the three-phase alternating-current synchronous motor is started, and the driving rotor lags behind to drive the driven rotor after rotating.

6. The three-phase alternating-current synchronous motor according to claim 4, wherein:
the driven rotor has a driven rotor body fixed relative to the rotor shaft;
the torque limiter includes a friction tong that rotates with the driven rotor body; an annular brake disc, a part of the brake disc is located in the jaws of the friction tong; and
the outer circumferential wall of the brake disc is fixed at least in the circumferential direction and the radial direction relative to the inner circumferential wall of the driving rotor.

7. The three-phase alternating-current synchronous motor according to claim 6, wherein:
the friction clamp includes a clamp body, a pair of friction plates forming a jaw and a pressure plate arranged in the clamp body, the pressure plate is fixed on the clamp body by a fastener, the pressure plate and the friction plate an elastic piece forcing the jaws to bite is interposed there between.

8. The three-phase alternating-current synchronous motor according to claim 4, wherein:
the driven rotor has a first driven rotor body fixed relative to the rotor shaft, and a second driven rotor body fixed circumferentially relative to the rotor shaft and axially sliding;
the torque limiter includes a plurality of passive friction plates fixed relative to the first driven rotor body and the second driven rotor body in the circumferential direction, and a plurality of driving friction plates fixed relative to the driving rotor in the circumferential direction, so the multiple pieces of passive friction plates and the multiple pieces of driving friction plates are alternately stacked in the axial direction and are subjected to positive pressure for generating friction in the axial direction; and
the outer peripheral wall of the driving friction plate is at least circumferentially fixed relative to the inner peripheral wall of the driving rotor.

9. The three-phase alternating-current synchronous motor according to claim 8, wherein:
the torque limiter further includes a first compression spring forcing the second driven rotor body to approach the first driven rotor body in the axial direction, pass through the spring seat hole on the first driven rotor body in the axial direction and fasten on the second driven rotor body, or pass through the spring seat hole on the second driven rotor body and fasten on the compression screw on the first driven rotor body; and
the first compression spring is arranged in the spring socket hole.

10. The three-phase alternating-current synchronous motor according to claim 9, wherein:
the torque limiter further includes a second compression spring for forcing the second driven rotor body to approach the first driven rotor body in the axial direction;
one end of the rotor shaft has a cylindrical cavity, the axial end surface of this end is provided with a pressure regulating screw that penetrates the cylindrical cavity in the axial direction, and the circumferential wall of the cylindrical cavity is provided with a radially penetrating waist circle Hole, the long axis of the waist round hole is along the axial direction, a pin passes through the waist round hole and is fastened to the second driven rotor body; and
the second compression spring is arranged in the cylinder of the rotor shaft and is pressed between the pressure regulating screw and the pin.

11. The three-phase alternating-current synchronous motor according to claim 8, wherein:
the driving rotor has a driving rotor cavity for sealingly accommodating the driven rotor, and the driving rotor cavity contains lubricating oil; and
the torque limiter is located in the driving rotor cavity.

12. The three-phase alternating-current synchronous motor according to claim 11, wherein:
one end of the rotor shaft has a cylindrical cavity, the axial end surface of this end is provided with a pressure regulating screw that axially penetrates the cylindrical cavity, and the circumferential wall of the cylindrical cavity is provided with a radially penetrating waist hole, the long axis of the waist round hole is along the axial direction, and a pin penetrates the waist round hole and presses against the axial end surface of the second driven rotor body facing away from the first driven rotor body; and
the cylindrical cavity is communicated with the driving rotor cavity through the waist round hole.

13. An electrical equipment, comprising:
industrial electric fans, air compressors, elevators, aerators or hoists, three-phase alternating-current synchronous motors, the three-phase alternating-current synchronous motors including a stator and a rotor, wherein:
the rotor includes a driving rotor and a driven rotor arranged coaxially;
the driven rotor is fixed with a rotor shaft; and
when starting, the driving rotor rotates first, and then drives the driven rotor to rotate.

14. The electrical equipment according to claim 13,
the driving rotor is connected with the driven rotor through a torque limiter.

15. The electrical equipment according to claim 14,
the torque limiter has a sliding torque that causes the driving rotor to slide relative to the driven rotor when the three-phase alternating-current synchronous motor is started, and the driving rotor lags behind to drive the driven rotor after rotating.

16. The electrical equipment according to claim 14,
the driven rotor has a driven rotor body fixed relative to the rotor shaft;
the torque limiter includes a friction tong that rotates with the driven rotor body; an annular brake disc, a part of the brake disc is located in the jaws of the friction tong; and
the outer circumferential wall of the brake disc is fixed at least in the circumferential direction and the radial direction relative to the inner circumferential wall of the driving rotor.

17. The electrical equipment according to claim 15,
the friction clamp includes a clamp body, a pair of friction plates forming a jaw and a pressure plate arranged in the clamp body, the pressure plate is fixed on the clamp body by a fastener, the pressure plate and the friction plate an elastic piece forcing the jaws to bite is interposed there between.

18. The electrical equipment of claim 14, wherein:
the driven rotor has a first driven rotor body fixed relative to the rotor shaft, and a second driven rotor body fixed circumferentially relative to the rotor shaft and axially sliding;
the torque limiter includes a plurality of passive friction plates fixed relative to the first driven rotor body and the second driven rotor body in the circumferential direction, and a plurality of driving friction plates fixed relative to the driving rotor in the circumferential direction, so the multiple pieces of passive friction plates and the multiple pieces of driving friction plates are alternately stacked in the axial direction and are subjected to positive pressure for generating friction in the axial direction; and
the outer peripheral wall of the driving friction plate is at least circumferentially fixed relative to the inner peripheral wall of the driving rotor.

19. The electrical equipment according to claim 18,
the torque limiter further includes a first compression spring forcing the second driven rotor body to approach the first driven rotor body in the axial direction, pass through the spring seat hole on the first driven rotor body in the axial direction and fasten on the second driven rotor body, or pass through the spring seat hole on the second driven rotor body and fasten on the compression screw on the first driven rotor body; and
the first compression spring is arranged in the spring socket hole.

20. The electrical equipment according to claim 19,
the torque limiter further includes a second compression spring for forcing the second driven rotor body to approach the first driven rotor body in the axial direction;
one end of the rotor shaft has a cylindrical cavity, the axial end surface of this end is provided with a pressure regulating screw that penetrates the cylindrical cavity in the axial direction, and the circumferential wall of the cylindrical cavity is provided with a radially penetrating waist circle Hole, the long axis of the waist round hole is along the axial direction, a pin passes through the waist round hole and is fastened to the second driven rotor body; and
the second compression spring is arranged in the cylinder of the rotor shaft and is pressed between the pressure regulating screw and the pin.
